(19) United States
(12) Patent Application Publication
(10) Pub. No.: US 2024/0410112 A1
(43) Pub. Date: Dec. 12, 2024

(54) SHEET MANUFACTURING APPARATUS AND CLEANING DEVICE

(71) Applicant: SEIKO EPSON CORPORATION, Tokyo (JP)

(72) Inventor: Tetsuya TAMURA, Matsumoto (JP)

(21) Appl. No.: 18/738,099

(22) Filed: Jun. 10, 2024

(30) Foreign Application Priority Data
Jun. 12, 2023 (JP) 2023-096080

(51) Int. Cl. D21F 1/32; D21F 1/00

(52) U.S. Cl. CPC D21F 1/32; D21F 1/0027

(57) ABSTRACT

A sheet manufacturing apparatus includes a processing roller configured to process a web containing fibers, a cleaning unit including a cleaning roller unit, a blade unit, and a hammer unit, and a control unit. The cleaning roller unit is configured to clean the processing roller, the blade unit is configured to clean the cleaning roller unit, and the control unit is configured to cause the hammer unit to apply an impact to the blade unit.

The present application is based on, and claims priority from JP Application Serial Number 2023-096080, filed Jun. 12, 2023, the disclosure of which is hereby incorporated by reference herein in its entirety.

### BACKGROUND

### 1. Technical Field

The present disclosure relates to a sheet manufacturing apparatus and a cleaning device.

### 2. Related Art

An apparatus for manufacturing a sheet or the like by compression-forming a web containing fibers derived from paper has been known. For example, JP-A-2022-156155 discloses a cleaning mechanism for removing paper dust adhering to a calender roller for forming. The above-described mechanism in a fiber structure manufacturing apparatus performs cleaning of the calender roller with a felt roller for cleaning being in contact with the calender roller.

However, the apparatus described in JP-A-2022-156155 has a problem in that it is difficult to maintain the cleaning ability with respect to the calender roller. Specifically, the felt roller is brought into contact with the calender roller, and then a remover is brought into contact with the felt roller. The paper dust adhered to the calender roller is transferred from the calender roller to the felt roller and then transferred from the felt roller to the remover. Therefore, when the paper dust transferred to the remover is accumulated, the cleaning ability of the remover is decreased, and thus the cleaning ability of the felt roller is decreased in some cases. That is, there is a need for a sheet manufacturing apparatus that maintains the cleaning ability of the roller for cleaning.

### SUMMARY

A sheet manufacturing apparatus includes a processing roller configured to process a web containing fibers, a cleaning unit including a cleaning roller unit, a blade unit, and a hammer unit, and a control unit. The cleaning roller unit is configured to clean the processing roller, the blade unit is configured to clean the cleaning roller unit, and the control unit is configured to cause the hammer unit to apply an impact to the blade unit.

A cleaning device includes a cleaning unit including a cleaning roller unit, a blade unit, and a hammer unit and configured to clean a forming member to which paper dust adheres, and a control unit. The cleaning roller unit is configured to clean the forming member, the blade unit is configured to clean the cleaning roller unit, and the control unit is configured to cause the hammer unit to apply an impact to the blade unit.

### BRIEF DESCRIPTION OF THE DRAWINGS

FIG. 1 is a schematic diagram illustrating a configuration of a sheet manufacturing apparatus according to an embodiment.

FIG. 2 is a perspective view illustrating arrangement of a forming unit and a cleaning unit.

FIG. 3 is a perspective view illustrating a configuration of a cleaning unit of a first cleaning device.

FIG. 4 is a side view illustrating arrangement of the cleaning unit of the first cleaning device.

FIG. 5 is a perspective view illustrating a configuration of a cleaning unit of a second cleaning device.

FIG. 6 is a side view illustrating arrangement of the cleaning unit of the second cleaning device.

FIG. 7 is an enlarged side view illustrating a configuration and arrangement of a hammer unit and the like.

FIG. 8 is a perspective view illustrating the configuration and the arrangement of the hammer unit and the like.

FIG. 9 is a perspective view illustrating an appearance of a lever portion and a striking portion of the hammer unit.

FIG. 10 is a side view illustrating arrangement of a gear group and the hammer unit of the second cleaning device.

FIG. 11 is a perspective view illustrating arrangement of a wind-up portion, a lever portion, and the like in the second cleaning device.

FIG. 12 is a perspective view illustrating the operating principle of a striking operation in the second cleaning device.

FIG. 13 is a perspective view illustrating the operating principle of the striking operation in the second cleaning device.

FIG. 14 is a side view illustrating a cleaning function by the cleaning unit of the second cleaning device.

FIG. 15 is a side view illustrating the cleaning function by the cleaning unit of the second cleaning device.

FIG. 16 is a side view illustrating the cleaning function by the cleaning unit of the second cleaning device.

FIG. 17 is a side view illustrating the cleaning function by the cleaning unit of the second cleaning device.

FIG. 18 is a side view illustrating the cleaning function by the cleaning unit of the second cleaning device.

FIG. 19 is a side view illustrating the cleaning function by the cleaning unit of the second cleaning device.

FIG. 20 is a side view illustrating a posture of the cleaning unit of the second cleaning device at the time of separation.

FIG. 21 is a side view illustrating a posture of the cleaning unit of the first cleaning device at the time of separation.

### DESCRIPTION OF EMBODIMENTS

In the following embodiment, a sheet manufacturing apparatus 1 that recycles paper pieces such as used paper in a dry process will be exemplified and described with reference to the accompanying drawings. The sheet manufacturing apparatus of the present disclosure is not limited to a dry type, and may be a wet type. Note that, in the present specification, the term “dry” means not to be performed in a liquid but to be performed in air, such as in the atmosphere.

In each of the following drawings, XYZ-axes are given as coordinate axes orthogonal to each other, a direction indicated by each arrow is set as a + direction, and a direction opposite to the + direction is set as a − direction. A Z-axis is a virtual axis along the vertical direction, and a +Z direction is an upward direction and a −Z direction is a downward direction. The −Z direction is a direction in which gravity acts. In addition, in the sheet manufacturing apparatus 1, a leading side in a transport direction of a raw material, a web, a sheet, and the like may be referred to as downstream, and a trailing side in the transport direction may be referred to as upstream. For convenience of illustration, the size of each member is different from the actual size.

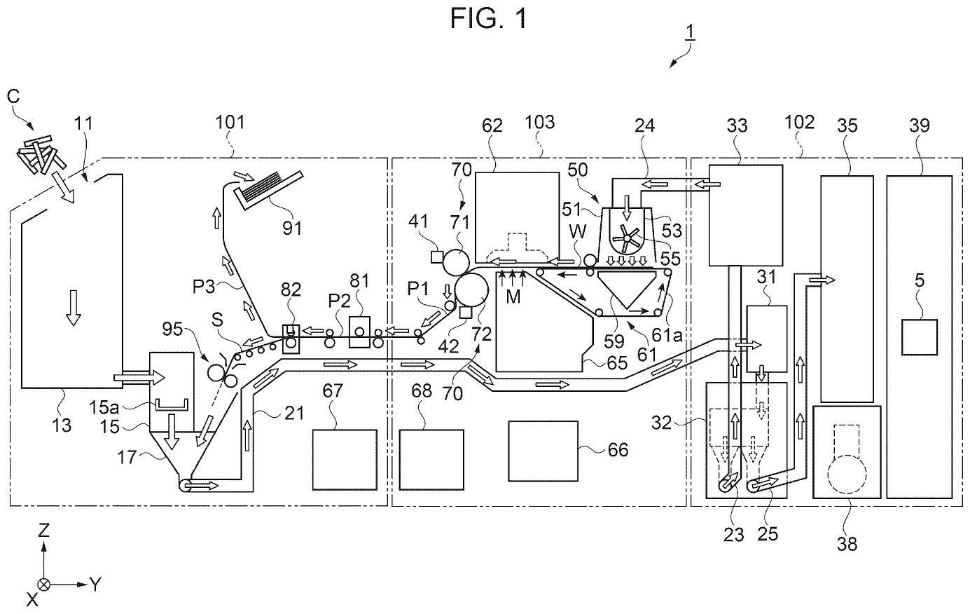

As illustrated in FIG. 1, the sheet manufacturing apparatus 1 according to the present embodiment includes a first unit group 101, a second unit group 102, and a third unit group 103. The first unit group 101, the second unit group 102, and the third unit group 103 are supported by a frame (not illustrated). Note that, in FIG. 1, directions in which used paper C, a sheet P3, a slit piece S, an unnecessary scrap, and the like move are indicated by outlined white arrows.

The sheet manufacturing apparatus 1 manufactures the sheet P3 from the used paper C. In the sheet manufacturing apparatus 1, the first unit group 101, the third unit group 103, and the second unit group 102 are arranged from a-Y direction to a +Y direction in side view in a-X direction.

The used paper C is transported from the first unit group 101 to the second unit group 102 through a pipe 21 crossing inside the third unit group 103. Then, the used paper C is subjected to defibration and the like in the second unit group 102 to become fibers, and the fibers then become a mixture containing a binder and the like. The mixture is transported to the third unit group 103 through a pipe 24. The mixture is formed into a web W in the third unit group 103 and then formed into a belt-shaped sheet P1. The belt-shaped sheet P1 is cut into the sheet P3 in the first unit group 101.

The first unit group 101 includes a buffer tank 13, a fixed-quantity supply unit 15, a merging unit 17, and the pipe 21. In the first unit group 101, these components are arranged in the above order from upstream to downstream. The first unit group 101 also includes a first cutting unit 81, a second cutting unit 82, a tray 91, and a shredding unit 95. The first cutting unit 81 and the second cutting unit 82 cut the belt-shaped sheet P1 into the sheet P3 having a predetermined shape. Further, the first unit group 101 includes a water supply unit 67. The water supply unit 67 is a water storage tank. The water supply unit 67 supplies water for humidification to each of a first humidifying unit 65 and a second humidifying unit 66, which will be described later, through a water supply pipe (not illustrated).

The used paper C is fed from a raw material input port 11 to the buffer tank 13. The used paper C contains fibers such as cellulose, and includes, for example, paper pieces of shredded used paper. The humidified air is supplied to the inside of the buffer tank 13 from the second humidifying unit 66 provided in the third unit group 103.

The used paper C to be defibrated is temporarily stored in the buffer tank 13 and then transported to the fixed-quantity supply unit 15 in accordance with the operation of the sheet manufacturing apparatus 1. The sheet manufacturing apparatus 1 may be provided with a shredder for shredding the used paper C and the like upstream of the buffer tank 13.

The fixed-quantity supply unit 15 includes a weighing device 15a and a supply mechanism (not illustrated). The weighing device 15a weighs mass of the used paper C. The supply mechanism supplies the used paper C weighed by the weighing device 15a to the downstream merging unit 17. That is, the fixed-quantity supply unit 15 weighs the used paper C for each predetermined mass by the weighing device 15a, and supplies the used paper C to the downstream merging unit 17 by the supply mechanism.

Either digital or analog weighing mechanism can be applied to the weighing device 15a. Specifically, examples of the weighing device 15a include a physical sensor such as a load cell, a spring scale, and a balance. In the present embodiment, the load cell is used as the weighing device 15a. The predetermined mass for which the weighing device 15a weighs the used paper C is, for example, about several grams to several tens of grams.

A known technique such as a vibration feeder can be applied to the supply mechanism. The supply mechanism may be included in the weighing device 15a.

The weighing and supply of the used paper C in the fixed-quantity supply unit 15 is a batch process. That is, the supply of the used paper C from the fixed-quantity supply unit 15 to the merging unit 17 is intermittently performed. The fixed-quantity supply unit 15 may include a plurality of weighing devices 15a, and the plurality of weighing devices 15a may be operated at different times to improve efficiency of weighing.

In the merging unit 17, shredded pieces of the slit piece S supplied from the shredding unit 95 are merged and mixed with the used paper C supplied from the fixed-quantity supply unit 15. The slit piece S and the shredding unit 95 will be described later. The used paper C mixed with the shredded pieces flows into the pipe 21 from the merging unit 17.

The pipe 21 transports the used paper C from the first unit group 101 to the second unit group 102 by airflow generated by a blower (not illustrated).

The second unit group 102 includes a defibrating unit 31 which is a dry defibrating machine, a separating unit 32, a pipe 23, a mixing unit 33, and the pipe 24. In the second unit group 102, these components are arranged in the above order from upstream to downstream. The second unit group 102 also includes a pipe 25 coupled to the separating unit 32, a collecting unit 35, a compressor 38, and a power supply unit 39.

The used paper C transported through the pipe 21 flows into the defibrating unit 31. The defibrating unit 31 defibrates the used paper C supplied from the fixed-quantity supply unit 15 into fibers in a dry process. A known defibrating mechanism can be applied to the defibrating unit 31.

The defibrating unit 31 includes the following configuration, for example. The defibrating unit 31 includes a stator and a rotor. The stator has a substantially cylindrical inner side surface. The rotor is installed inside the stator and rotates along the inner side surface of the stator. Small pieces of the used paper C are sandwiched between the inner side surface of the stator and the rotor, and are defibrated by shearing force generated therebetween. As a result, entangled fibers contained in paper pieces of the used paper C are untangled. The used paper C is formed into fibers and transported to the separating unit 32.

The separating unit 32 separates the defibrated fibers. Specifically, the separating unit 32 removes components which are included in the fibers and are unnecessary for manufacturing the sheet P3. Specifically, the separating unit 32 separates relatively long fibers from relatively short fibers. Since relatively short fibers may cause a decrease in strength of the sheet P3, the fibers are separated by the separating unit 32. In addition, the separating unit 32 also separates and removes coloring materials and additives contained in the used paper C. A known technique such as a disk mesh method can be applied to the separating unit 32.

The humidified air is supplied from the second humidifying unit 66 of the third unit group 103 to the inside of the separating unit 32.

Relatively short fibers and the like are removed from the defibrated fibers, and the defibrated fibers are transported to the mixing unit 33 through the pipe 23. Unnecessary components such as relatively short fibers and coloring materials are discharged to the collecting unit 35 through the pipe 25.

The mixing unit 33 mixes the fibers with a binder and the like in the air to form a mixture. Although not illustrated, the mixing unit 33 includes a flow path through which the fibers are transported, a fan, a hopper, a supply pipe, and a valve.

The hopper communicates with the flow path of the fibers through the supply pipe. The valve is provided with the supply pipe between the hopper and the flow path. The hopper supplies a binder such as starch into the flow path. The valve adjusts mass of the binder supplied from the hopper to the flow path. Thus, the mixing ratio of the fibers and the binder is adjusted.

In addition to the above-described configuration for supplying the binder, the mixing unit 33 may include a similar configuration for supplying a coloring material, an additive, or the like.

The fan of the mixing unit 33 generates airflow to mix the binder and the like with the fibers in the air to form a mixture while the fibers are transported downstream. The mixture flows into the pipe 24 from the mixing unit 33. The collecting unit 35 includes a filter (not illustrated). The filter filters unnecessary components such as relatively short fibers transported through the pipe 25 by the airflow.

The compressor 38 generates compressed air. In the filter, clogging may occur due to fine particles or the like in the unnecessary components. The compressed air generated by the compressor 38 can be blown onto the filter to blow off adhering particles and perform cleaning of the filter.

The power supply unit 39 includes a control unit 5 and a power supply device (not illustrated) that supplies power to the sheet manufacturing apparatus 1. The power supply unit 39 distributes power supplied from the outside to each of the components of the sheet manufacturing apparatus 1. The control unit 5 is electrically coupled to each of the components of the sheet manufacturing apparatus 1, and integrally controls the operation of these components.

The third unit group 103 accumulates and compresses the mixture containing the fibers, and forms into the belt-shaped sheet P1 which is recycled paper. The third unit group 103 includes an accumulation unit 50, a first transport unit 61, a second transport unit 62, the first humidifying unit 65, the second humidifying unit 66, a drain unit 68, a forming unit 70, and cleaning units 41 and 42.

In the third unit group 103, the accumulation unit 50, the first transport unit 61, the second transport unit 62, the first humidifying unit 65, the forming unit 70, and the cleaning units 41 and 42 are arranged in the above order from upstream to downstream. The second humidifying unit 66 is arranged below the first humidifying unit 65.

The accumulation unit 50 generates the web W by accumulating the mixture containing the separated fibers in the air. The accumulation unit 50 includes a drum member 53, a blade member 55 installed in the drum member 53, a housing 51 that accommodates the drum member 53, and a suction unit 59. The mixture is taken into the drum member 53 from the pipe 24.

The first transport unit 61 is arranged below the accumulation unit 50. The first transport unit 61 includes a mesh belt 61a and five stretch rollers (not illustrated) for stretching the mesh belt 61a. The suction unit 59 faces the drum member 53 with the mesh belt 61a interposed therebetween in the direction along the Z-axis.

The blade member 55 is arranged inside the drum member 53 and is rotationally driven by a motor (not illustrated). The drum member 53 is a semi-columnar sieve. A net having a function of the sieve is provided on a side surface of the drum member 53 facing downward. The drum member 53 causes particles of fibers and mixtures smaller than the size of the mesh of the sieve to pass through from the inside to the outside.

The mixture is discharged to the outside of the drum member 53 while being stirred by the rotating blade member 55 in the drum member 53. The humidified air is supplied from the second humidifying unit 66 to the inside of the drum member 53.

The suction unit 59 is arranged below the drum member 53. The suction unit 59 sucks the air in the housing 51 through a plurality of holes of the mesh belt 61a. The plurality of holes of the mesh belt 61a causes air to pass therethrough, but do not cause fibers, a binder, and the like contained in the mixture to pass therethrough easily. Thus, the mixture discharged to the outside of the drum member 53 is sucked downward together with the air. The suction unit 59 is a known suction device such as a blower.

The mixture is dispersed in the air in the housing 51 and accumulated on an upper surface of the mesh belt 61a by gravity and suction of the suction unit 59 to form the web W.

The mesh belt 61a is an endless belt and is stretched by the five stretch rollers. The mesh belt 61a is rotated counterclockwise in FIG. 1 by the rotation of the stretch rollers. As a result, the mixture is continuously accumulated on the mesh belt 61a to form the web W. The web W contains a relatively large amount of air and is soft and expanded. The first transport unit 61 transports the formed web W downstream by a rotational move of the mesh belt 61a.

The second transport unit 62 transports the web W in place of the first transport unit 61 downstream of the first transport unit 61. The second transport unit 62 peels the web W off from the upper surface of the mesh belt 61a and transports the web W toward the forming unit 70. The second transport unit 62 is arranged above the transport path of the web W and slightly upstream of a starting point of a return section of the mesh belt 61a. The second transport unit 62 in the +Y direction and the mesh belt 61a in the −Y direction partially overlap in the vertical direction.

The second transport unit 62 includes a transport belt, a plurality of rollers, and a suction mechanism, which are not illustrated. The transport belt is provided with a plurality of holes through which air passes. The transport belt is stretched by the plurality of rollers and is rotationally moved by the rotation of the rollers.

The second transport unit 62 causes an upper surface of the web W to be attracted to a surface of the transport belt below by negative pressure generated by the suction mechanism. When the transport belt rotationally moves in this state, the web W is attracted to the transport belt and transported downstream.

The first humidifying unit 65 humidifies the web W containing fibers accumulated in the accumulation unit 50 of the third unit group 103. Specifically, the first humidifying unit 65 is, for example, a mist humidifier, and humidifies the web W transported by the second transport unit 62, by supplying mist M from below. The first humidifying unit 65 is arranged below the second transport unit 62 and faces the web W transported by the second transport unit 62 in the direction along the Z-axis. For example, a known humidifying device such as an ultrasonic type can be applied to the first humidifying unit 65. By humidifying the web W with the mist M, the function of the starch as a binder is promoted, and strength of the sheet P3 is improved. In addition, since the web W is humidified from below, drops derived from the mist are prevented from falling onto the web W. Further, since the web W is humidified from the side opposite to the contact surface between the transport belt and the web W, sticking of the web W with respect to the transport belt is reduced. The second transport unit 62 transports the web W to the forming unit 70.

The forming unit 70 includes processing rollers 71 and 72. The processing rollers 71 and 72 process the web W containing fibers to form the belt-shaped sheet P1. The processing rollers 71 and 72 form a pair, each of which has an electric heater built therein and has a function of raising the temperature of the roller surface.

Each of the processing rollers 71 and 72 is a substantially columnar member. A rotation shaft of the processing roller 71 and a rotation shaft of the processing roller 72 are arranged along an X-axis. The processing roller 71 is arranged substantially above the transport path of the web W, and the processing roller 72 is arranged substantially below the transport path of the web W. Between a side surface of the processing roller 71 and a side surface of the processing roller 72, a gap corresponding to the thickness of the sheet P3 to be manufactured is provided.

The processing rollers 71 and 72 are rotationally driven by a stepping motor (not illustrated). The web W is sandwiched between the processing roller 71 and the processing roller 72 and fed downstream while being heated and pressurized. That is, the web W continuously passes through the forming unit 70, and is press-formed while being heated. By using the processing rollers 71 and 72 as a pair of forming members, the web W can be efficiently heated and pressurized.

By the web W passing through the forming unit 70, the air contained in the web W is reduced from a soft state in which the web W contains a relatively large volume of air, and the fibers of the web W are bonded to each other by the binder, whereby the web W is formed into the belt-shaped sheet P1. The belt-shaped sheet P1 is transported to the first unit group 101 by a transport roller (not illustrated).

The cleaning unit 41 corresponds to the processing roller 71, and the cleaning unit 42 corresponds to the processing roller 72. The cleaning unit 41 and the control unit 5 constitute a cleaning device 401 to be described later. The cleaning unit 42 and the control unit 5 constitute a cleaning device 402 to be described later.

As described above, the processing rollers 71 and 72 sandwich and press the web W. Therefore, paper dust, fibers, and the like derived from the used paper C contained in the web W are likely to adhere to each of the side surfaces of the processing rollers 71 and 72. When the forming is continued while the paper dust and the like is adhered, defects such as contamination or roughness of the surface or a decrease in sheet strength may occur in the sheet P3 to be manufactured. The cleaning unit 41 cleans the processing roller 71, and the cleaning unit 42 cleans the processing roller 72.

The second humidifying unit 66 is arranged below the first humidifying unit 65. A known vaporization type humidifying device can be applied to the second humidifying unit 66. Examples of the vaporization type humidifying device include a humidifying device that generates humidified air by blowing air to a wetted nonwoven fabric or the like to vaporize moisture.

The second humidifying unit 66 humidifies a predetermined region of the sheet manufacturing apparatus 1. The predetermined region is one or more of the buffer tank 13, the separating unit 32, and the inside of the drum member 53 of the accumulation unit 50. Specifically, the humidified air is supplied from the second humidifying unit 66 to the above-described region through a plurality of pipes (not illustrated). The humidified air suppresses charging of the used paper C, fibers, and the like in each of the above-described configurations, and suppresses adhesion of these to members due to static electricity.

The drain unit 68 is a drain tank. The drain unit 68 collects and stores old moisture that is used in the first humidifying unit 65, the second humidifying unit 66, and the like. The drain unit 68 can be removed from the sheet manufacturing apparatus 1 as necessary, and the accumulated water can be discarded.

The belt-shaped sheet P1 transported to the first unit group 101 reaches the first cutting unit 81. The first cutting unit 81 cuts the belt-shaped sheet P1 in the direction intersecting the transport direction, for example, in the direction along the X-axis. The belt-shaped sheet P1 is cut into a single-cut shape sheet P2 by the first cutting unit 81. The single-cut shape sheet P2 is transported from the first cutting unit 81 to the second cutting unit 82.

The second cutting unit 82 cuts the single-cut shape sheet P2 in the transport direction, for example, in the direction along a Y-axis. Specifically, the second cutting unit 82 cuts the single-cut shape sheet P2 in the vicinity of both sides in the direction along the X-axis. As a result, the single-cut shape sheet P2 becomes the sheet P3 having a predetermined shape such as A4 size or A3 size.

When the single-cut shape sheet P2 is cut into the sheet P3 in the second cutting unit 82, the slit piece S, which is a scrap, is produced. The slit piece S is transported substantially in the −Y direction and reach the shredding unit 95 which is a shredder. The shredding unit 95 shreds the slit piece S and supplies the slit piece S as shredded pieces to the merging unit 17. A mechanism for weighing and supplying the shredded pieces of the slit piece S to the merging unit 17 may be installed between the shredding unit 95 and the merging unit 17.

The sheet P3 is transported substantially upward and stacked on the tray 91. As described above, the sheet P3 is manufactured by the sheet manufacturing apparatus 1. The sheet P3 can be applied as a substitute for copy paper, for example.

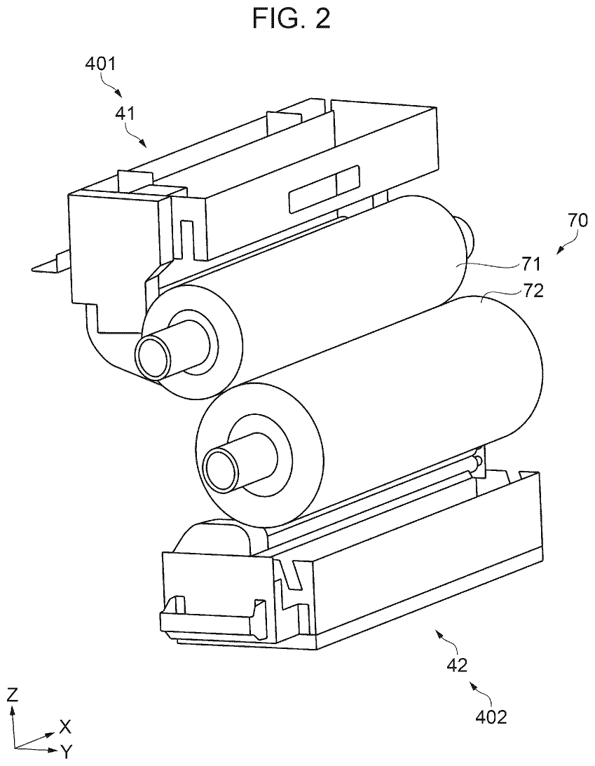

As illustrated in FIG. 2, the cleaning unit 41 is arranged slightly higher than the processing roller 71 in the −Y direction and along the processing roller 71. The cleaning unit 42 is arranged lower than the processing roller 72 and nearer to the −Y direction and along the processing roller 72.

The cleaning device 401 includes the control unit 5 described above and the cleaning unit 41. The cleaning device 402 includes the control unit 5 and the cleaning unit 42. Note that, each of the cleaning devices 401 and 402 may individually include a control unit.

In the direction along the X-axis, the length of the cleaning unit 41 is substantially equal to the length of the side surface of the processing roller 71. Similarly, the length of the cleaning unit 42 is substantially equal to the length of the processing roller 72.

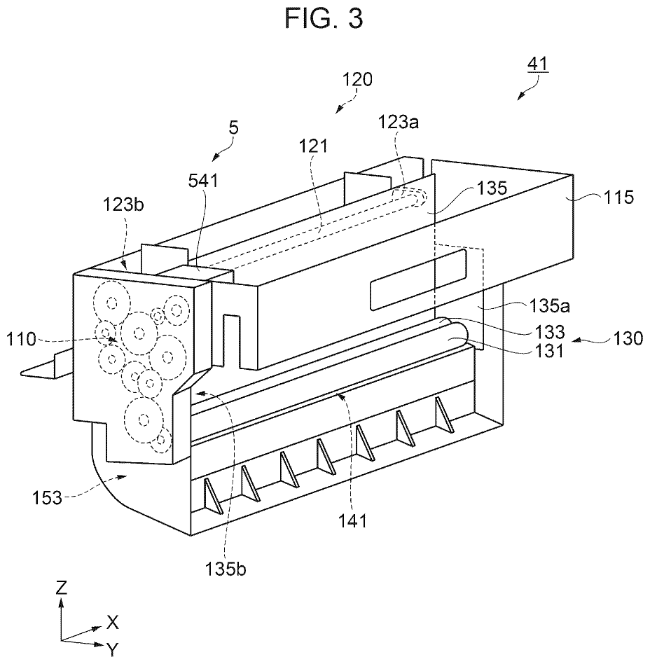

As illustrated in FIG. 3, the cleaning unit 41 includes a cleaning roller unit 130, a blade unit 141, an operation unit 120, a gear group 110, a paper dust collecting unit 153, a support member 135, and a frame unit 115. The cleaning unit 41 also includes a hammer unit 144 to be described later. Note that, in FIG. 3, a cleaning roller drive motor 541 included in the control unit 5 is also illustrated.

The cleaning roller unit 130 includes a first cleaning roller 131 and a second cleaning roller 133. The cleaning roller unit 130 cleans the processing roller 71. The hammer unit 144 cleans the blade unit 141.

The first cleaning roller 131 is a substantially columnar member, and the height direction of the column is arranged along the X-axis. Both end portions of the first cleaning roller 131 in the direction along the X-axis are supported by the support member 135, and the first cleaning roller 131 rotates about a rotation shaft along the X-axis. The first cleaning roller 131 is rotationally driven by one of the gears of the gear group 110.

The second cleaning roller 133 is a substantially columnar member, and is arranged side by side with the first cleaning roller 131 in the direction along the Y-axis, and the height direction of the column is also arranged along the X-axis. Both end portions of the second cleaning roller 133 in the direction along the X-axis are supported by the support member 135, and the second cleaning roller 133 rotates about the rotation shaft along the X-axis. The second cleaning roller 133 is also rotationally driven by one of the gears of the gear group 110.

The blade unit 141 extends along a side surface of the second cleaning roller 133. The blade unit 141 is supported by the support member 135.

The operation unit 120 includes a shaft unit 121 and cam members 123a and 123b. The shaft unit 121 is a rod-shaped member disposed along the X-axis. The cam member 123a is attached in the vicinity of an end portion of the shaft unit 121 in a +X direction, and the cam member 123b is attached in the vicinity of an end portion of the shaft unit 121 in the −X direction.

The shaft unit 121 is supported by the frame unit 115 and rotates about a rotation shaft along the X-axis. The end portion of the shaft unit 121 in the −X direction is directly coupled to one of the gears of the gear group 110. When the gear group 110 is driven, the shaft portion 121 is rotationally driven. The cam members 123a and 123b rotate about the shaft unit 121 as the rotation center in conjunction with the rotation of the shaft unit 121.

The gear group 110 includes a plurality of gears that are not illustrated. The plurality of gears are rotated by the driving of the cleaning roller drive motor 541 to rotate the shaft unit 121, the first cleaning roller 131, and the second cleaning roller 133. The gear group 110 and the cleaning roller drive motor 541 are installed at an end portion of the frame unit 115 in the −X direction.

The support member 135 includes, in plan view from above, a main body (not illustrated) along an XZ-plane and support units 135a and 135b protruding in the +Y direction from respective end portions of the main body in the direction along the X-axis. The support units 135a and 135b face each other in the direction along the X-axis. The operation unit 120, the first cleaning roller 131, the second cleaning roller 133, and the blade unit 141 are arranged between the support units 135a and 135b. That is, the support units 135a and 135b support the operation unit 120, the first cleaning roller 131, the second cleaning roller 133, and the blade unit 141.

The support member 135 can change its posture relative to the frame unit 115 while being supported by the frame unit 115. The posture change of the support member 135 will be described later.

The frame unit 115 is a substantially frame-shaped member in plan view from above, and the support member 135 is arranged in the inner side thereof. The gear group 110 is arranged in the −X direction, which is outside, and the cleaning roller drive motor 541 is arranged in the +X direction, which is inside, relative to the end portion in the −X direction of the frame unit 115. The cleaning roller drive motor 541 includes a shaft (not illustrated) that is an output shaft. The shaft extends in the −X direction through the frame unit 115 and is directly coupled to one of the plurality of gears of the gear group 110. The frame unit 115 is supported by the frame of the third unit group 103 of the sheet manufacturing apparatus 1.

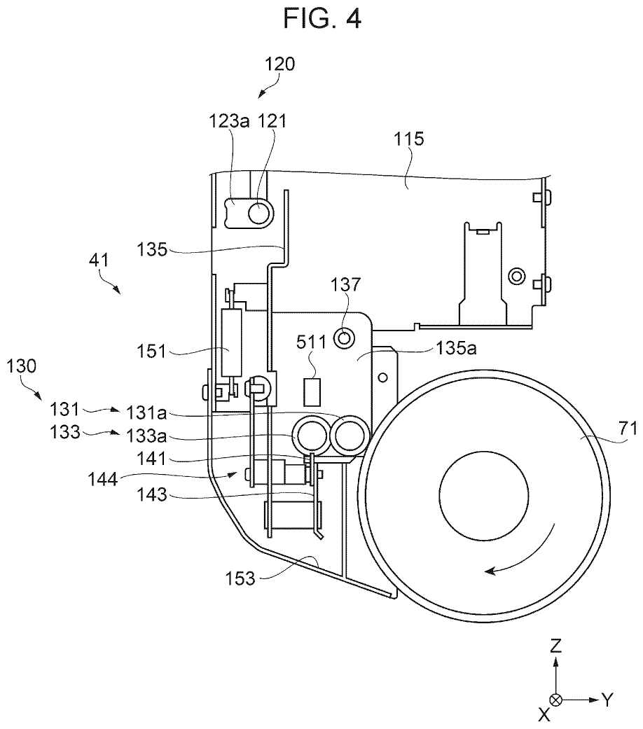

As illustrated in FIG. 4, in the cleaning unit 41, the first cleaning roller 131 is arranged slightly higher than the processing roller 71 while being in contact therewith in the −Y direction. FIG. 4 illustrates a state in which the first cleaning roller 131 is in contact with the processing roller 71 to clean the side surface of the processing roller 71. Here, in the description of FIG. 4, a state in side view in the −X direction will be described unless otherwise specified.

The first cleaning roller 131 cleans the processing roller 71. Specifically, the first cleaning roller 131 includes a cleaning layer 131a on the outer periphery portion of the side surface. The cleaning layer 131a comes into contact with the side surface of the processing roller 71 to clean the side surface of the processing roller 71.

The cleaning layer 131a cleans the paper dust and the like adhering to the processing roller 71. Therefore, the cleaning ability of the cleaning roller unit 130 with respect to the processing roller 71 is improved.

The cleaning layer 131a of the first cleaning roller 131 is made of a felt material. Therefore, the paper dust and the like is easily entangled in the cleaning layer 131a. In addition, the cleaning layer 131a easily follows the shape of the side surface of the processing roller 71. Thus, the cleaning ability of the first cleaning roller 131 to clean the processing roller 71 is further improved.

The second cleaning roller 133 cleans the first cleaning roller 131. Specifically, the second cleaning roller 133 includes a brush-shaped surface layer 133a on the outer periphery portion of the side surface. In the surface layer 133a, a plurality of bristle materials are installed substantially radially from the rotation center. The cleaning layer 131a and the surface layer 133a of the first cleaning roller 131 are arranged so as to overlap each other. As a result, the surface layer 133a comes into contact with the cleaning layer 131a of the first cleaning roller 131 to clean the first cleaning roller 133.

The paper dust and the like transferred from the processing roller 71 to the first cleaning roller 131 is cleaned by the surface layer 133a, and the cleanliness of the first cleaning roller 131 is maintained. Therefore, the cleaning ability of the cleaning roller unit 130 with respect to the processing roller 71 is easily maintained.

The processing roller 71, the first cleaning roller 131, and the second cleaning roller 133 rotate clockwise.

The blade unit 141 is arranged below the second cleaning roller 133. The blade unit 141 is a substantially rectangular plate-shaped member, and a principal surface thereof extends along the XZ-plane. The blade unit 141 comes into contact with the surface layer 133a of the second cleaning roller 133 and cleans the surface layer 133a of the second cleaning roller 133 in the cleaning roller unit 130. In the direction along the X-axis, the length of the blade unit 141 is substantially equal to the length of the surface layer 133a of the second cleaning roller 133.

The blade unit 141 is supported by the support member 135 with a fixing member 143 interposed therebetween, and is arranged such that an upper end portion thereof is embedded in the plurality of bristle materials of the surface layer 133a. A distance to embed the blade unit 141 with respect to the surface layer 133a is, for example, substantially 1 mm.

In the second cleaning roller 133, the paper dust and the like transferred from the first cleaning roller 131 is cleaned by the blade unit 141, thereby maintaining cleanliness. Therefore, the cleaning ability of the cleaning roller unit 130 with respect to the processing roller 71 is easily maintained.

The support member 135 is rotatably supported by the frame unit 115 with a rotation shaft 137 as the rotation center. A spring member 151 is arranged along the Z-axis in the −Y direction of the support member 135. In the spring member 151, an upper end portion is fixed to the support member 135, and a lower end portion is fixed to the frame unit 115.

The support member 135 is biased by the spring member 151 in the counterclockwise direction about the rotation shaft 137 as the rotation center. Therefore, the first cleaning roller 131 is brought into contact with the processing roller 71 by biasing force of the spring member 151.

The operation unit 120 is arranged in the −Y direction with respect to an upper end portion of the support member 135 and faces the support member 135 in the direction along the Y-axis. The cam member 123a and the cam member 123b (not illustrated) rotate to switch between contact and separation of the first cleaning roller 131 with and from the processing roller 71. That is, the control unit 5 controls the operation unit 120 to switch between contact and separation of the first cleaning roller 131 with and from the processing roller 71.

Thus, the first cleaning roller 131 can be appropriately separated from the processing roller 71. Compared to when the first cleaning roller 131 is constantly in contact with the processing roller 71, the occurrence of wear and deformation of the cleaning layer 131a in the first cleaning roller 131 is suppressed. Note that, the processing of the web W described above is performed when the first cleaning roller 131 is in contact with the processing roller 71.

Each of the cam members 123a and 123b has an asymmetric shape with respect to the shaft unit 121 serving as the rotation center, and has a protruding portion (not illustrated). When the first cleaning roller 131 is brought into contact with the processing roller 71, the protruding portion is moved in a direction substantially opposite to the upper end portion of the support member 135 to separate the cam members 123a and 123b from an upper end portion of the support member 135.

When the first cleaning roller 131 is separated from the processing roller 71, the shaft unit 121 rotates and the protruding portion comes into contact with the upper end of the support member 135. Therefore, the protruding portion biases the upper end portion substantially in the +Y direction, and the support member 135 rotates clockwise by a certain distance. As a result, the support member 135 changes its posture, and the first cleaning roller 131 is separated from the processing roller 71.

The control unit 5 includes a sensor unit 511. The sensor unit 511 detects an amount of paper dust and the like adhering to the surface layer 133a of the second cleaning roller 133. When the amount of paper dust reaches a predetermined value, that is, when a certain amount of paper dust is transferred to the second cleaning roller 133, the control unit 5 separates the first cleaning roller 131 from the processing roller 71. Then, the control unit 5 causes the hammer unit 144 to clean the blade unit 141.

Examples of the sensor unit 511 include a known RGB image sensor. The predetermined amount of paper dust that has reached and adhered to the second cleaning roller 133 is, for example, a surface area.

The paper dust collecting unit 153 is arranged below the second cleaning roller 133 and the blade unit 141. The paper dust collecting unit 153 is a box-shaped member whose upper side is opened, and mainly collects and stores the paper dust and the like falling from the second cleaning roller 133 and the blade unit 141. The paper dust and the like stored in the paper dust collecting unit 153 can be removed by detaching the paper dust collecting unit 153 from the sheet manufacturing apparatus 1.

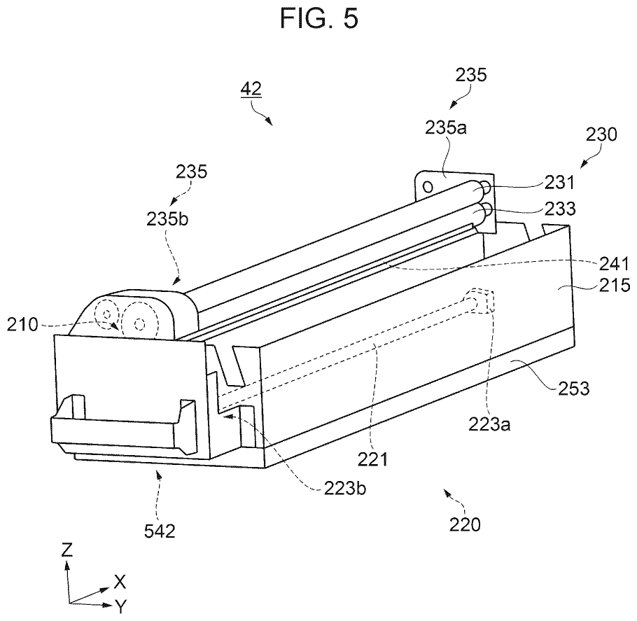

As illustrated in FIG. 5, the cleaning unit 42 includes a cleaning roller unit 230, a blade unit 241, an operation unit 220, a gear group 210, a paper dust collecting unit 253, a support member 235, and a frame unit 215. The cleaning unit 42 also includes a hammer unit 244 to be described later. Note that, in FIG. 5, a cleaning roller drive motor 542 included in the control unit 5 is also illustrated.

The cleaning roller unit 230 includes a first cleaning roller 231 and a second cleaning roller 233. The cleaning roller unit 230 cleans the processing roller 72. The hammer unit 244 cleans the blade unit 241.

The first cleaning roller 231 is a substantially columnar member, and the height direction of the column is arranged along the X-axis. Both end portions of the first cleaning roller 231 in the direction along the X-axis are supported by the support member 235, and the first cleaning roller 231 rotates about a rotation shaft along the X-axis. The first cleaning roller 231 is rotationally driven by one of the gears of the gear group 210.

The second cleaning roller 233 is a substantially columnar member, and is arranged side by side with the first cleaning roller 231 in the direction along the Z-axis, and the height direction of the column is also arranged along the X-axis. Both end portions of the second cleaning roller 233 in the direction along the X-axis are supported by the support member 235, and the second cleaning roller 233 rotates about the rotation shaft along the X-axis. The second cleaning roller 233 is also rotationally driven by one of the gears of the gear group 210.

The blade unit 241 extends along a side surface of the second cleaning roller 233. The blade unit 241 is supported by the support member 235.

The operation unit 220 includes a shaft unit 221 and cam members 223a and 223b. The shaft unit 221 is a rod-shaped member arranged along the X-axis. In the shaft unit 221, the cam member 223a is attached in the vicinity of an end portion in the +X direction, and the cam member 223b is attached in the vicinity of an end portion in the −X direction.

The shaft unit 221 is supported by the frame unit 215 and rotates about a rotation shaft along the X-axis. The end portion of the shaft unit 221 in the −X direction is directly coupled to one of the gears of the gear group 210. When the gear group 210 is driven, the shaft unit 221 is rotationally driven. The cam members 223a and 223b rotate about the shaft unit 221 as the rotation center in conjunction with the rotation of the shaft unit 221.

The gear group 210 includes a plurality of gears that are not illustrated. The plurality of gears are rotated by driving of the cleaning roller drive motor 542 to rotate the shaft unit 221, the first cleaning roller 231, and the second cleaning roller 233. The gear group 210 and the cleaning roller drive motor 542 are installed at an end portion of the frame unit 215 in the −X direction.

The support member 235 includes, in plan view from above, a main body (not illustrated) along the XZ-plane and support units 235a and 235b protruding upward from respective end portions of the main body in the direction along the X-axis. The support units 235a and 235b face each other in the direction along the X-axis. The operation unit 220, the first cleaning roller 231, the second cleaning roller 233, and the blade unit 241 are arranged between the support units 235a and 235b. That is, the support units 235a and 235b support the operation unit 220, the first cleaning roller 231, the second cleaning roller 233, and the blade unit 241.

The support member 235 can change its posture relative to the frame unit 215 while being supported by the frame unit 215. The posture change of the support member 235 will be described later.

The frame unit 215 is a substantially frame-shaped member in plan view from above, and the support member 235 is arranged inside the frame unit 215. The gear group 210 is arranged in the −X direction, which is outside, and the cleaning roller drive motor 542 is arranged in the +X direction, which is inside, relative to the end portion in the −X direction of the frame unit 215. The cleaning roller drive motor 542 includes a shaft (not illustrated) that is an output shaft. The shaft extends in the −X direction through the frame unit 215 and is directly coupled to one of the plurality of gears of the gear group 210. The frame unit 215 is supported by the frame of the third unit group 103 of the sheet manufacturing apparatus 1.

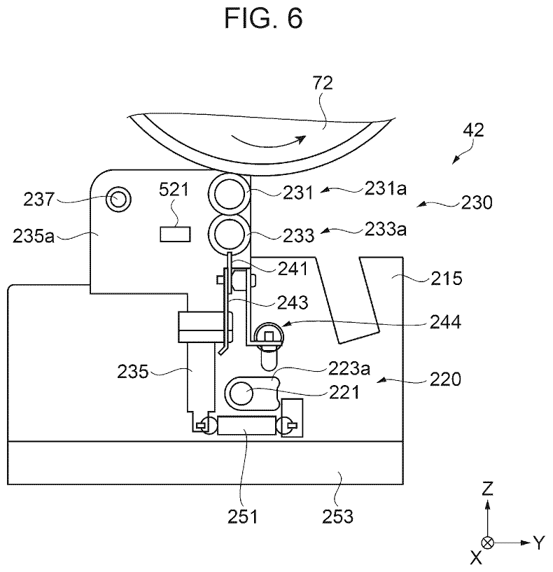

As illustrated in FIG. 6, in the cleaning unit 42, the first cleaning roller 231 is arranged in the −Y direction of the processing roller 72 at a slightly lower portion thereof while being in contact therewith. FIG. 6 illustrates a state in which the first cleaning roller 231 is in contact with the processing roller 72 to clean the side surface of the processing roller 72. Here, in the description of FIG. 6, a state in side view in the −X direction will be described unless otherwise specified.

The first cleaning roller 231 cleans the processing roller 72. Specifically, the first cleaning roller 231 includes a cleaning layer 231a on the outer periphery portion of the side surface. The cleaning layer 231a comes into contact with the side surface of the processing roller 72 to clean the side surface of the processing roller 72.

The paper dust and the like adhering to the processing roller 72 is cleaned by the cleaning layer 231a. Therefore, the cleaning ability of the cleaning roller unit 230 with respect to the processing roller 72 is improved.

The cleaning layer 231a of the first cleaning roller 231 is made of a felt material. Therefore, the paper dust and the like are easily entangled in the cleaning layer 231a. In addition, the cleaning layer 231a easily follows the shape of the side surface of the processing roller 72. Thus, the cleaning ability of the first cleaning roller 231 to clean the processing roller 72 is further improved.

The second cleaning roller 233 cleans the first cleaning roller 231. Specifically, the second cleaning roller 233 includes a brush-like surface layer 233a on the outer periphery portion of the side surface. On the surface layer 233a, a plurality of bristle materials are installed substantially radially from the rotation center. The cleaning layer 231a and the surface layer 233a of the first cleaning roller 231 are arranged so as to overlap each other. As a result, the surface layer 233a comes into contact with the cleaning layer 231a of the first cleaning roller 231 to clean the first cleaning roller 231.

The paper dust and the like transferred from the processing roller 72 to the first cleaning roller 231 is cleaned by the surface layer 233a, and the cleanliness of the first cleaning roller 231 is maintained. Therefore, the cleaning ability of the cleaning roller unit 230 with respect to the processing roller 72 is easily maintained.

The processing roller 72, the first cleaning roller 231, and the second cleaning roller 233 rotate counterclockwise.

The blade unit 241 is arranged below the second cleaning roller 233. The blade unit 241 is a substantially rectangular plate-shaped member, and a principal surface thereof extends along the XZ-plane. The blade unit 241 comes into contact with the surface layer 233a of the second cleaning roller 233 and cleans the surface layer 233a of the second cleaning roller 233 in the cleaning roller unit 230. In the direction along the X-axis, the length of the blade unit 241 is substantially equal to the length of the surface layer 233a of the second cleaning roller 233.

The blade unit 241 is supported by the support member 235 with a fixing member 243 interposed therebetween, and is arranged such that an upper end portion thereof is embedded in the plurality of bristle materials of the surface layer 233a. A distance to embed the blade unit 241 with respect to the surface layer 233a is, for example, substantially 1 mm.

The blade unit 241 cleans the second cleaning roller 233 to remove the paper dust and the like transferred from the first cleaning roller 231, thereby maintaining cleanliness. Therefore, the cleaning ability of the cleaning roller unit 230 with respect to the processing roller 72 is easily maintained.

The support member 235 is rotatably supported by the frame unit 215 with a rotation shaft 237 as the rotation center. A spring member 251 is arranged along the Y-axis below the support member 235. In the spring member 251, an end portion in the −Y direction is fixed to the support member 235, and an end portion in the +Y direction is fixed to the frame unit 215.

The support member 235 is biased by the spring member 251 in the counterclockwise direction about the rotation shaft 237 as the rotation center. Therefore, the first cleaning roller 231 is brought into contact with the processing roller 72 by biasing force of the spring member 251.

The operation unit 220 is arranged in the +Y direction with respect to a lower end portion of the support member 235 and faces the support member 235 in the direction along the Y-axis. The cam member 223a and the cam member 223b (not illustrated) switch between contact and separation of the second cleaning roller 233 with and from the processing roller 72 by the rotation. That is, the control unit 5 controls the operation unit 220 to switch between contact and separation of the first cleaning roller 231 with and from the processing roller 72.

Thus, the first cleaning roller 231 can be appropriately separated from the processing roller 72. Compared to when the first cleaning roller 231 is constantly in contact with the processing roller 72, the occurrence of wear and deformation of the cleaning layer 231a in the first cleaning roller 231 is suppressed. Note that, the above-described processing of the web W is performed when the first cleaning roller 231 is in contact with the processing roller 72.

Each of the cam members 223a and 223b has an asymmetric shape with respect to the shaft unit 221 serving as the rotation center, and has a protruding portion (not illustrated). When the first cleaning roller 231 is brought into contact with the processing roller 72, the protruding portion is positioned in a direction substantially opposite to an upper end portion of the support member 235 to separate the cam members 223a and 223b from the lower end portion of the support member 235.

When the first cleaning roller 231 is separated from the processing roller 72, the shaft unit 221 rotates and the protruding portion comes into contact with the upper end portion of the support member 235. Therefore, the protruding portion biases the upper end portion substantially in the −Y direction, and the support member 235 rotates clockwise by a certain distance. As a result, the support member 235 changes its posture, and the first cleaning roller 231 is separated from the processing roller 72.

The control unit 5 includes a sensor unit 521. The sensor unit 521 detects the amount of paper dust and the like adhering to the surface layer 233a of the second cleaning roller 233. When the amount of paper dust reaches a predetermined value, that is, when a certain amount of paper dust is transferred to the second cleaning roller 233, the control unit 5 separates the first cleaning roller 231 from the processing roller 72. Then, the control unit 5 causes the hammer unit 244 to clean the blade unit 241. Cleaning of the blade unit 241 will be described later.

Examples of the sensor unit 521 include a known RGB image sensor. The predetermined amount of paper dust that has reached and adhered to the second cleaning roller 233 is, for example, a surface area.

The paper dust collecting unit 253 is arranged below the second cleaning roller 233 and the blade unit 241. The paper dust collecting unit 253 is a box-shaped member whose upper side is opened, and mainly collects and stores the paper dust and the like falling from the second cleaning roller 233 and the blade unit 241. The paper dust and the like stored in the paper dust collecting unit 253 can be removed by detaching the paper dust collecting unit 253 from the sheet manufacturing apparatus 1.

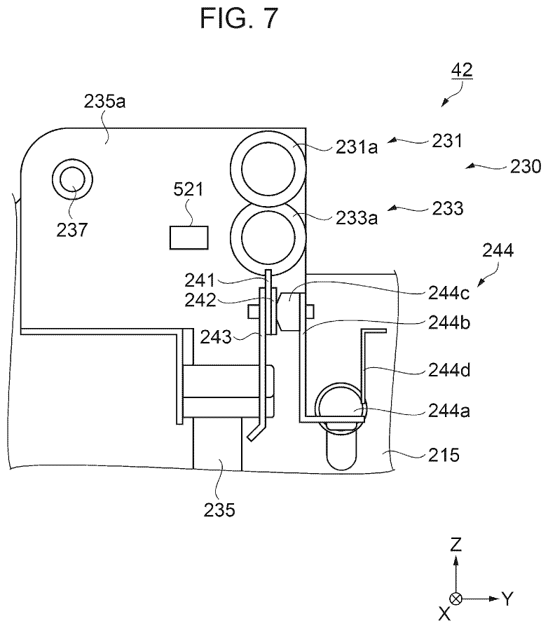

With reference to FIG. 7 to FIG. 13, a configuration, an operation, and the like of the hammer unit 244 included in the cleaning unit 42 will be described. Note that, the cleaning unit 41 and the cleaning unit 42 are different from each other in terms of arrangement, but are the same in terms of basic configuration and operation. Therefore, the cleaning unit 42 will be described as a representative example, and description of the hammer unit 144 and the like of the cleaning unit 41 will be omitted.

As illustrated in FIG. 7, the hammer unit 244 of the cleaning unit 42 includes a shaft portion 244a, an arm portion 244b, a striking portion 244c, and a spring portion 244d. Although not illustrated, the hammer unit 244 also includes a wind-up portion and a lever portion. The wind-up portion is one of the plurality of gears of the gear group 210 described above. Here, FIG. 7 illustrates a state in which a striking operation, which will be described later, of the hammer unit 244 is not performed.

The shaft portion 244a extends along the X-axis and is rotatably supported by the frame unit 215 about a rotation shaft along the X-axis. The arm portion 244b and the spring portion 244d are fixed to the shaft portion 244a.

The arm portion 244b faces the fixing member 243 in the direction along the Y-axis. The striking portion 244c is arranged at an upper end portion of the arm portion 244b.

The blade unit 241 is fixed to an upper end portion of the fixing member 243 so as to protrude upward. An impact receiving portion 242 is attached in the +Y direction of the blade unit 241. In other words, the blade unit 241 is sandwiched between the fixing member 243 and the impact receiving portion 242. The impact receiving portion 242 is fixed to the fixing member 243 at a position where the impact receiving portion 242 is brought into contact with the striking portion 244c.

The striking portion 244c is arranged at the upper end portion of the arm portion 244b so as to face the −Y direction while being in contact with the impact receiving portion 242. As the striking operation of the hammer unit 244, the striking portion 244c is once separated from the impact receiving portion 242 at the initial stage of the striking operation by the hammer unit 244, and then comes into contact with the impact receiving portion 242 while striking the same. Accordingly, the impact of striking of the striking portion 244c is propagated to the blade unit 241 via the impact receiving portion 242. The impact has an effect of knocking off paper pieces and the like adhered to the blade unit 241 from the blade unit 241.

Since the impact is indirectly applied to the blade unit 241 by the impact receiving portion 242, breakage or the like is less likely to occur in the blade unit 241. In addition, the paper dust and the like adhering to the blade unit 241 is less likely to adhere to the striking portion 244c, and thus contamination to the striking portion 244c is suppressed.

The spring portion 244d is arranged so as to generate biasing force to the shaft portion 244a in the rotation direction with respect to the rotation shaft of the shaft portion 244a. Specifically, the spring portion 244d is, for example, a torsion coil spring, one end of which is fixed to the shaft portion 244a and the other end of which is fixed to the frame unit 215. Accordingly, in side view in the −X direction, the shaft portion 244a is biased counterclockwise, and the striking portion 244c is pressed against the impact receiving portion 242.

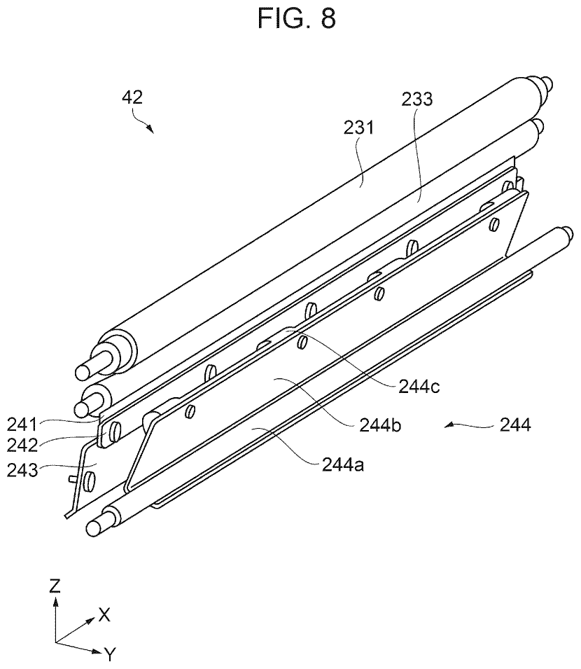

As illustrated in FIG. 8, the impact receiving portion 242 is a substantially plate-shaped member and extends in the direction along the X-axis. In the direction along the X-axis, the respective lengths of the blade unit 241, the impact receiving portion 242, and the upper end portion of the arm portion 244b are substantially equal. Note that, FIG. 8 illustrates a state in which the striking portion 244c and the impact receiving portion 242 are separated.

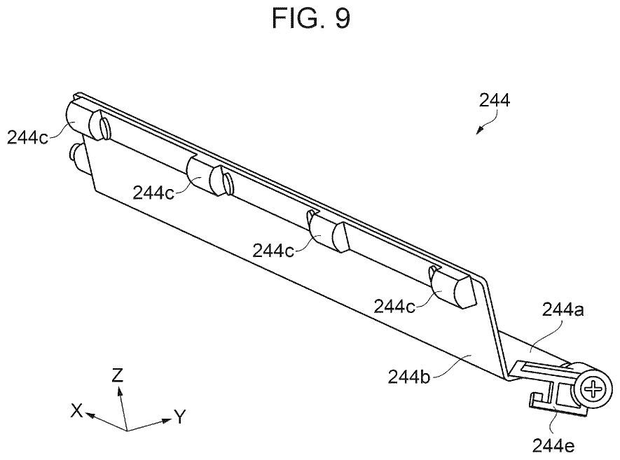

As illustrated in FIG. 9, a lever portion 244e is fixed to an end portion of the shaft portion 244a in the −X direction. The striking portions 244c are four protrusions protruding in the −Y direction. Four striking portions 244c are arranged along the X-axis. Each striking portion 244c protrudes in a circular arc shape in the −Y direction in side view in the −X direction. In the striking operation of the hammer unit 244, the region protruding in the circular arc shape strikes the impact receiving portion 242, and an impact is applied to the blade unit 241. Note that, the shape, arrangement, and number of the striking portions 244c are not limited to those described above.

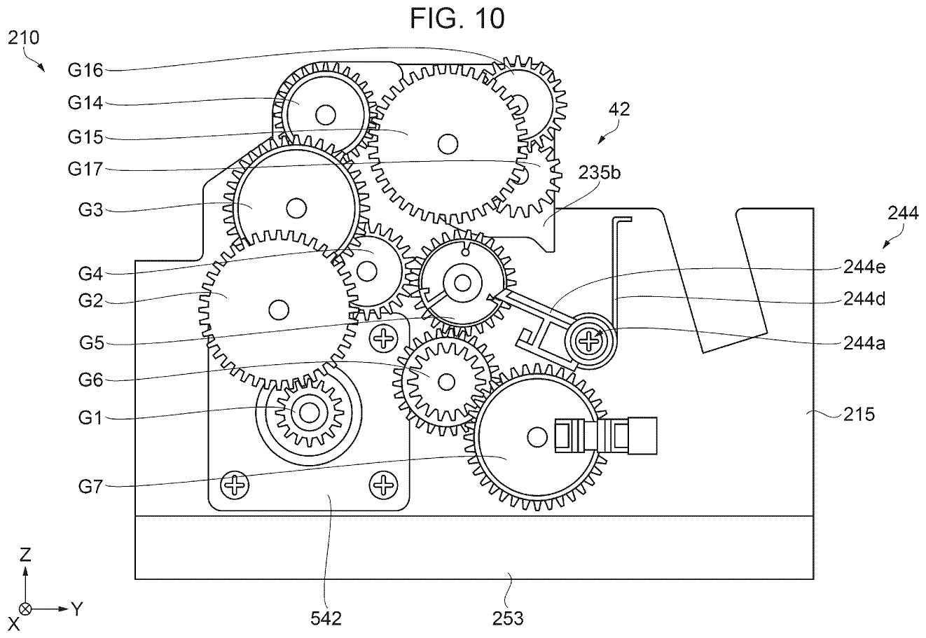

As illustrated in FIG. 10, the gear group 210 includes gears G1, G2, G3, G4, G5, G6, and G7, and gears G14, G15, G16, and G17. The gear G1 to the gear G7, and the gear G14 to the gear G17 are each arranged in the above sequence in engagement with one another. The gear G1 is directly coupled to an output shaft of the cleaning roller drive motor 542. Each gear of the gear group 210 rotates about a rotation shaft along the X-axis.

The rotational driving force of the cleaning roller drive motor 542 is transmitted from the gear G1 to the gear G2. The gear G2 includes a gear, not illustrated, that engages with the gear G3 in the +X direction of the gear that engages with the gear G1. Therefore, the rotational driving force is transmitted from the gear G2 to the gear G3, and further from the gear G3 to the gear G4, the gear G5, the gear G6, and the gear G7 sequentially. Further, the rotational driving force is also sequentially transmitted from the gear G3 to the gear G14, the gear G15, and the gears G16 and G17.

The lever portion 244e of the hammer unit 244 is arranged corresponding to the gear G5 which is the wind-up portion. The lever portion 244e is biased in a clockwise direction with the shaft portion 244a as a rotation shaft by being in contact with and riding on a convex portion, which will be described later, of the gear G5.

An end portion of the first cleaning roller 231 in the −X direction is fixed to the gear G16. An end portion of the second cleaning roller 233 in the −X direction is fixed to the gear G17.

When the cleaning roller drive motor 542 is driven counterclockwise in side view in the −X direction, the rotational driving force is sequentially transmitted, and the gears G5 and G7 rotate counterclockwise. As a result, the striking operation of the hammer unit 244, and the posture change of the support member 235 by the operation unit 220 are performed.

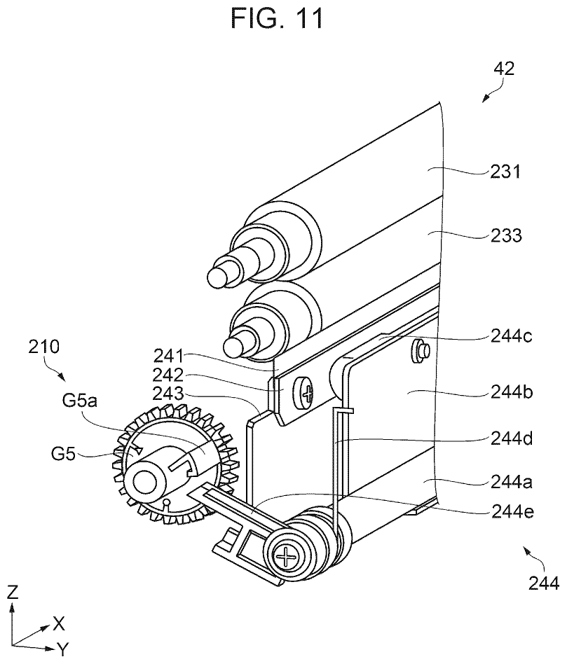

As illustrated in FIG. 11, the gear G5, which is the wind-up portion of the hammer unit 244, has a convex portion G5a. The convex portion G5a is arranged in the −X direction of the gear G5. In side view in the −X direction, the convex portion G5a has a shape protruding from a rotation shaft of the gear G5 in a moving radius direction of the gear G5. Here, in the following description of FIG. 11 to FIG. 13, a state in side view in the −X direction will be described unless otherwise specified.

In plan view from above, the convex portion G5a is located at a position where the convex portion G5a intersects with and being in contact with a tip end of the lever portion 244e when the gear G5 rotates. In FIG. 11, the convex portion G5a and the lever portion 244e are separated. At this time, the striking portion 244c is in contact with the impact receiving portion 242 by the biasing of the spring portion 244d in the counterclockwise direction.

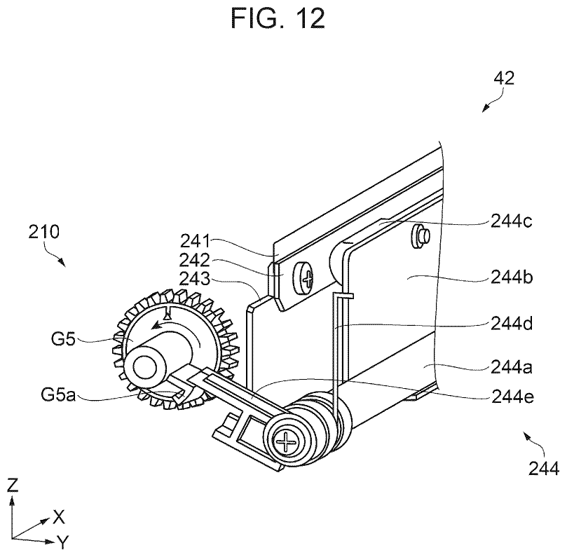

Next, as illustrated in FIG. 12, when the gear G5 rotates counterclockwise, the tip end of the lever portion 244e is brought into contact with the convex portion G5a. Even in this state, the striking portion 244c is in contact with the impact receiving portion 242.

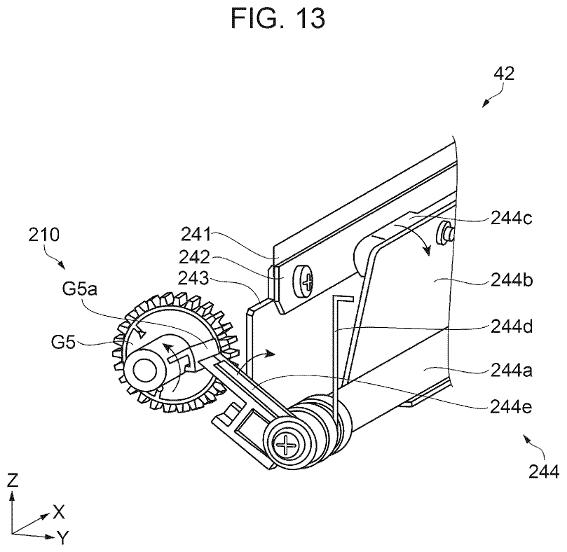

Next, as illustrated in FIG. 13, when the gear G5 further rotates counterclockwise, the tip end of the lever portion 244e rides on the convex portion G5a. As a result, the lever portion 244e is biased clockwise, and rotational force in the clockwise direction acts on the shaft portion 244a. That is, the gear G5 applies compression force to the spring portion 244d via the lever portion 244e.

The biasing force in the counterclockwise direction by the spring portion 244d acts on the shaft portion 244a, but the above compression force exceeds the biasing force. Therefore, the shaft portion 244a and the arm portion 244b rotate clockwise, and the striking portion 244c is separated from the impact receiving portion 242.

Next, when the gear G5 further rotates in the counterclockwise direction, the convex portion G5a and the tip end of the lever portion 244e are separated. As a result, the rotational force acted on the lever portion 244e and the shaft portion 244a by the convex portion G5a is eliminated, and the compression force by the gear G5 is released. Then, at the moment when the convex portion G5a and the lever portion 244e are separated, the shaft portion 244a is quickly rotated counterclockwise by repulsive force of the spring portion 244d against the compression force. Thus, the striking portion 244c strikes the impact receiving portion 242 to apply an impact to the blade unit 241. The principle of the striking operation by the hammer unit 244 has been described above.

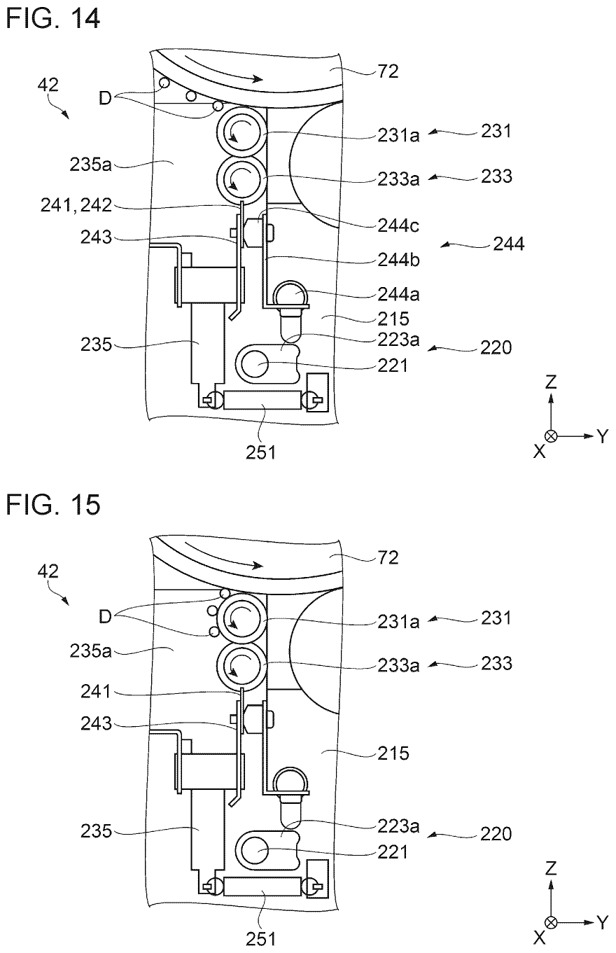

A cleaning function of the cleaning unit 42 will be described with reference to FIG. 14 to FIG. 19. The cleaning unit 41 and the cleaning unit 42 are different in arrangement but have the same cleaning function. Therefore, the cleaning unit 42 will be described as a representative example, and the description of the cleaning function of the cleaning unit 41 will be omitted. Note that, in the description of FIG. 14 to FIG. 19, a state in side view in the −X direction is described unless otherwise specified.

As illustrated in FIG. 14, paper dust D from the web W described above may adhere to the side surface of the processing roller 72 due to the operation of the sheet manufacturing apparatus 1.

The cleaning layer 231a of the first cleaning roller 231 is in contact with the side surface of the processing roller 72. When the first cleaning roller 231 is in contact with the processing roller 72, the processing roller 72, the first cleaning roller 231, and the second cleaning roller 233 rotate counterclockwise. At this time, the cleaning layer 231a of the first cleaning roller 231 is pressed against the side surface of the processing roller 72 by biasing of the spring member 251.

Next, as illustrated in FIG. 15, the paper dust D adhering to the side surface of the processing roller 72 reaches a region where the processing roller 72 and the cleaning layer 231a are in contact with each other by the rotation of the processing roller 72. Then, the first cleaning roller 231 comes into contact with the processing roller 72 while rotating, thereby cleaning the side surface of the processing roller 72. That is, the paper dust D adhering to the side surface of the processing roller 72 is entangled by the cleaning layer 231a and is transferred to the first cleaning roller 231.

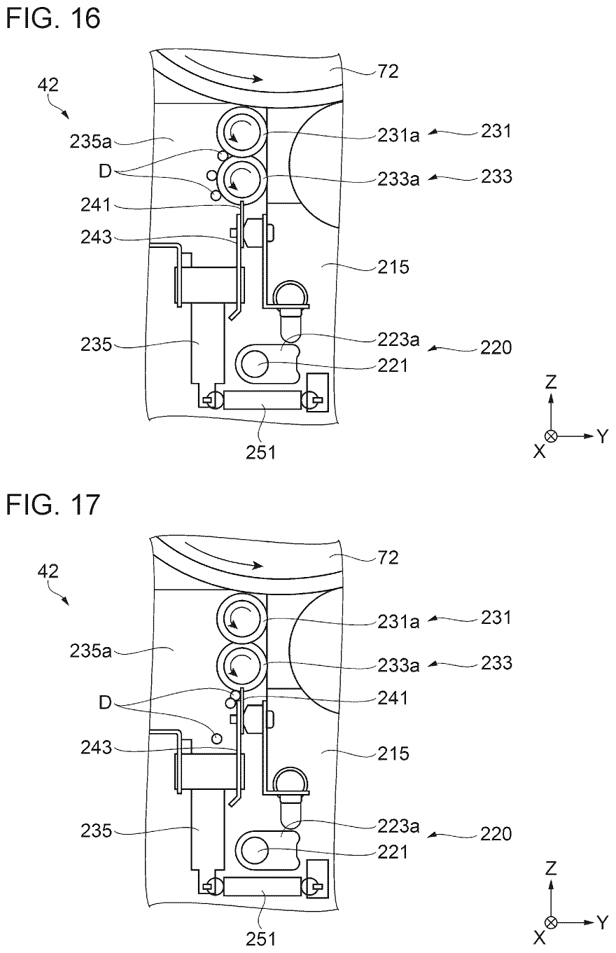

Next, as illustrated in FIG. 16, the paper dust D transferred to the cleaning layer 231a is entangled with the bristle materials of the surface layer 233a of the second cleaning roller 233 and transferred to the second cleaning roller 233. Thus, the cleaning layer 231a of the first cleaning roller 231 is cleaned, and the cleaning ability of the first cleaning roller 231 is maintained.

Next, as illustrated in FIG. 17, the paper dust D transferred to the surface layer 233a of the second cleaning roller 233 is scraped off by the blade unit 241 by the rotation of the second cleaning roller 233. As a result, the surface layer 233a of the second cleaning roller 233 is cleaned, and the cleaning ability of the second cleaning roller 233 with respect to the first cleaning roller 231 is maintained.

Although not illustrated, as described above, the sensor unit 521 detects the amount of paper dust D adhering to the second cleaning roller 233. When the amount of the paper dust D reaches a predetermined value, the control unit 5 causes the hammer unit 244 to apply an impact to the blade unit 241 by the above-described striking operation. Since the striking operation of the hammer unit 244 is automatically performed under the control of the control unit 5, the convenience of a user of the sheet manufacturing apparatus 1 can be improved.

The state in which a predetermined amount of the paper dust D adheres to the second cleaning roller 233 is, for example, a state in which the paper dust D adhering to the blade unit 241 is saturated. In this state, the cleaning ability of the blade unit 241 to clean the second cleaning roller 233 is decreased, and the cleaning ability of the second cleaning roller 233 to clean the first cleaning roller 231 is also decreased. Therefore, the paper dust D adhering to the blade unit 241 is removed by the impact, the cleaning ability of the blade unit 241 is recovered, and the cleaning ability of the second cleaning roller 233 is also recovered.

The predetermined amount of the paper dust D may be set to a low value, and the striking operation may be performed before the paper dust D adhering to the blade unit 241 is saturated. According to this, the cleaning ability of the first cleaning roller 231 can be kept high.

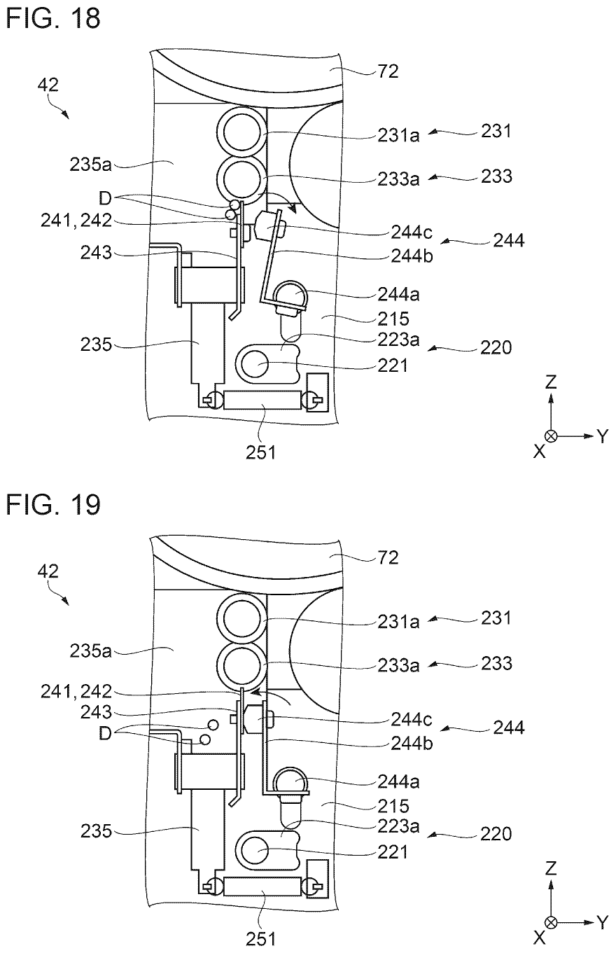

That is, as illustrated in FIG. 18, the gear G5 is rotated to rotate the shaft portion 244a and the arm portion 244b clockwise by a certain distance. Accordingly, the striking portion 244c is separated from the impact receiving portion 242. Then, the gear G5 is further rotated, and as illustrated in FIG. 19, the shaft portion 244a and the arm portion 244b are instantaneously rotated counterclockwise by the repulsive force of the spring portion 244d. Therefore, the striking portion 244c strikes the impact receiving portion 242, and the impact is applied to the blade unit 241. As a result, the paper dust D adhering to the blade unit 241 falls and is collected in the paper dust collecting unit 253 (not illustrated).

As a result, the cleaning ability of the cleaning unit 42 with respect to the processing roller 72 is maintained. As described above, the function of the cleaning unit 41 is the same as that of the cleaning unit 42. Therefore, same as the cleaning unit 42, the cleaning ability of the cleaning unit 41 corresponding to the processing roller 71 is also maintained.

In FIG. 18 and FIG. 19, the striking operation of the hammer unit 244 is performed in a state where the processing roller 72 and the first cleaning roller 231 are in contact with each other, but the present disclosure is not limited thereto. The above-described control unit 5 may cause the hammer unit 244 to apply the impact to the blade unit 241 when the first cleaning roller 231 is separated from the processing roller 72.

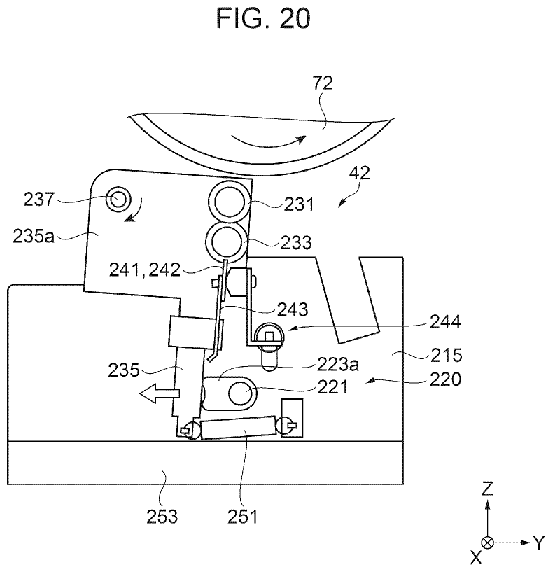

The operation unit 220 is caused to separate the first cleaning roller 231 from the processing roller 72. Specifically, from the state of FIG. 6 described above, as illustrated in FIG. 20, the posture of the support member 235 is changed by the operation unit 220. Specifically, the shaft unit 221 is rotated to bring the protruding portion of the cam member 223a into contact with the lower end portion of the support member 235 from the +Y direction. Although not illustrated, the cam member 223b moves in conjunction with the cam member 223a, and comes into contact with the lower end portion of the support member 235 corresponding to the cam member 223b from the +Y direction.

At this time, each lower end portion of the support member 235 is biased substantially in the −Y direction by being in contact with the cam members 223a and 223b. This biasing force is larger than that of the spring member 251. Therefore, the support member 235 rotates clockwise about the rotation shaft 237 as the rotation center by a certain distance. Then, the first cleaning roller 231 is separated from the processing roller 72.

Accordingly, when the processing of the web W is in progress, no impact is applied from the hammer unit 244 to the blade unit 241. Therefore, vibrations such as an impact applied to the hammer unit 244 and reaction force of the impact are not propagated to the processing roller 72 and the like. Therefore, in the belt-shaped sheet P1 formed from the web W, deterioration in quality, such as thickness, and the like can be prevented.

For the same reason, in the cleaning unit 41, the impact may be applied from the hammer unit 144 to the blade unit 141 when the first cleaning roller 131 is separated from the processing roller 71.

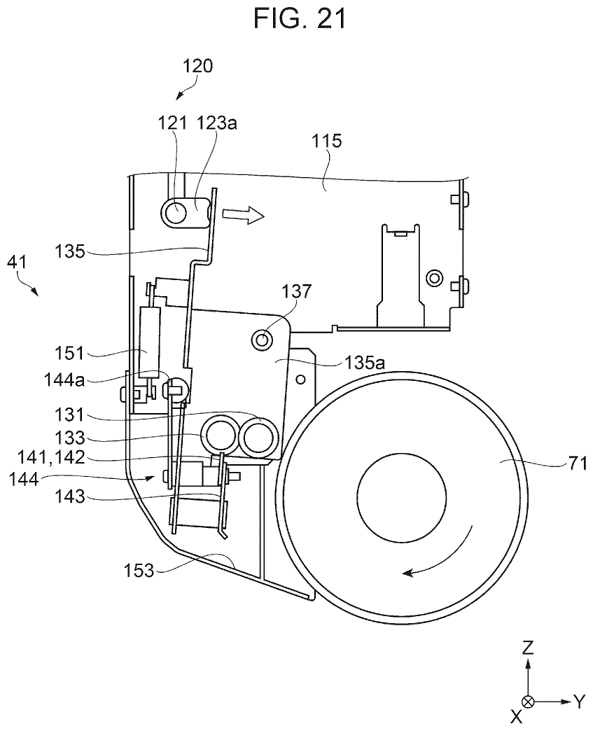

The operation unit 120 is caused to separate the first cleaning roller 131 from the processing roller 71. Specifically, from the state of FIG. 4 described above, as illustrated in FIG. 21, the posture of the support member 135 is changed by the operation unit 120. Specifically, the shaft unit 121 is rotated to bring the protruding portion of the cam member 123a into contact with the upper end portion of the support member 135 from the +Y direction. Note that, although not illustrated, the cam member 123b moves in conjunction with the cam member 123a, and comes into contact with the upper end portion of the support member 135 corresponding to the cam member 123b from the +Y direction.

At this time, each upper end portion of the support member 135 is biased substantially in the +Y direction by being in contact with the cam members 123a and 123b. This biasing force is larger than that of the spring member 151. Therefore, the support member 135 rotates clockwise about the rotation shaft 137 as the rotation center by a certain distance. Then, the first cleaning roller 131 is separated from the processing roller 71.

According to the present embodiment, the following effects can be obtained.

The cleaning ability of the cleaning roller units 130 and 230 can be maintained. Specifically, the paper dust D and the like adhering to the processing roller 71 are cleaned, and the paper dust D and the like are transferred to the cleaning roller unit 130. The paper dust D and the like transferred to the cleaning roller unit 130 are scraped off by the blade unit 141 and transferred to the blade unit 141. The paper dust D and the like transferred to the blade unit 141 are knocked off from the blade unit 141 by the impact from the hammer unit 144.

Similarly, the paper dust D and the like adhered to the processing roller 72 are cleaned, and the paper dust D and the like are transferred to the cleaning roller unit 230. The paper dust D and the like transferred to the cleaning roller unit 230 are scraped off by the blade unit 241 and transferred to the blade unit 241. The paper dust D and the like transferred to the blade unit 241 are knocked off from the blade unit 241 by the impact from the hammer unit 244.

Therefore, the paper dust D and the like are less likely to accumulate on the cleaning roller units 130 and 230, and the blade units 141 and 241, and the cleanliness of the cleaning roller units 130 and 230 is maintained. As a result, the cleaning ability of the cleaning roller units 130 and 230 corresponding to the processing rollers 71 and 72 is maintained. Therefore, the sheet manufacturing apparatus 1 and the cleaning devices 401 and 402 configured to maintain the cleaning ability of the cleaning roller units 130 and 230 can be provided.

What is claimed is:

1. A sheet manufacturing apparatus, comprising:
a processing roller configured to process a web containing fibers;
a cleaning unit including a cleaning roller unit, a blade unit, and a hammer unit; and
a control unit, wherein
the cleaning roller unit is configured to clean the processing roller,
the blade unit is configured to clean the cleaning roller unit, and
the control unit is configured to cause the hammer unit to apply an impact to the blade unit.

2. The sheet manufacturing apparatus according to claim 1, wherein
the cleaning roller unit includes a first cleaning roller being in contact with the processing roller, and
the first cleaning roller includes a cleaning layer configured to clean the processing roller.

3. The sheet manufacturing apparatus according to claim 2, wherein
the cleaning roller unit includes a second cleaning roller being in contact with the first cleaning roller, and
the second cleaning roller includes a surface layer having a brush-like shape and configured to clean the first cleaning roller.

4. The sheet manufacturing apparatus according to claim 3, wherein
the blade unit is in contact with the surface layer of the second cleaning roller.

5. The sheet manufacturing apparatus according to claim 1, wherein
the hammer unit includes a wind-up portion, a lever portion, a spring portion, and a striking portion,
the wind-up portion applies compression force to the spring portion via the lever portion, and
the striking portion applies the impact to the blade unit by repulsive force of the spring portion against the compression force when the compression force by the wind-up portion is released.

6. The sheet manufacturing apparatus according to claim 5, wherein
the cleaning unit includes an impact receiving portion attached to the blade unit,
the striking portion of the hammer unit strikes the impact receiving portion, and
the impact is propagated to the blade unit via the impact receiving portion.

7. The sheet manufacturing apparatus according to claim 2, wherein
the cleaning unit includes an operation unit, and
the control unit controls the operation unit to switch between contact and separation of the first cleaning roller with and from the processing roller.

8. The sheet manufacturing apparatus according to claim 7, wherein
processing of the web is performed when the first cleaning roller is in contact with the processing roller, and
the control unit causes the hammer unit to apply the impact to the blade unit when the first cleaning roller is separated from the processing roller.

9. The sheet manufacturing apparatus according to claim 8, wherein
the control unit
includes a sensor unit configured to detect an amount of paper dust adhering to a second cleaning roller, and
causes the first cleaning roller to separate from the processing roller and causes the hammer unit to apply the impact to the blade unit when the amount of paper dust reaches a predetermined value.

10. A cleaning device, comprising:
a cleaning unit including a cleaning roller unit, a blade unit, and a hammer unit and configured to clean a forming member to which paper dust adheres; and
a control unit, wherein
the cleaning roller unit is configured to clean the forming member,
the blade unit is configured to clean the cleaning roller unit, and
the control unit is configured to cause the hammer unit to apply an impact to the blade unit.
